(19) United States
(12) Patent Application Publication
(10) Pub. No.: US 2008/0100260 A1
(43) Pub. Date: May 1, 2008

(54) Charging control method for lithium battery

(76) Inventors: Chih-Min Hsu, Hsinchu (TW); Dar-Cherng Su, Hsinchu (TW); Albert Chen, Hsinchu (TW); Cheng-Chieh Ku, Hsinchu (TW); Jui-Liang Wang, Hsinchu (TW); Charles Huang, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/649,763

(22) Filed: Jan. 5, 2007

(30) Foreign Application Priority Data
Oct. 27, 2006 (TW) 95139634

(51) Int. Cl. H02J 7/00

(52) U.S. Cl. 320/107

(57) ABSTRACT

A charging control method of lithium battery is provided. At the beginning, a voltage detect circuit detects the current voltage of the battery and the microprocessor decides a proper charging stage, and then modulates a power as an appropriate constant current or an appropriate constant voltage by the pulse width modulation (PWM) function of the microprocessor to charge the battery. Next, repeatedly detects the voltage, decides the charging stage, charges the battery, compares the voltage of the battery with the default voltage . . . and so on until the charging process is completed.

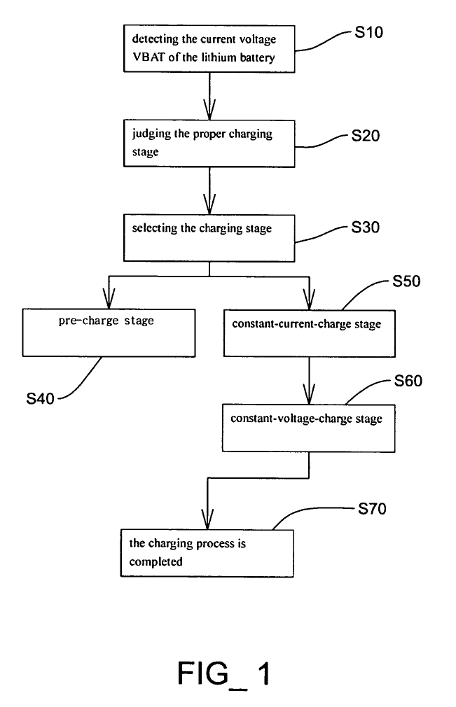

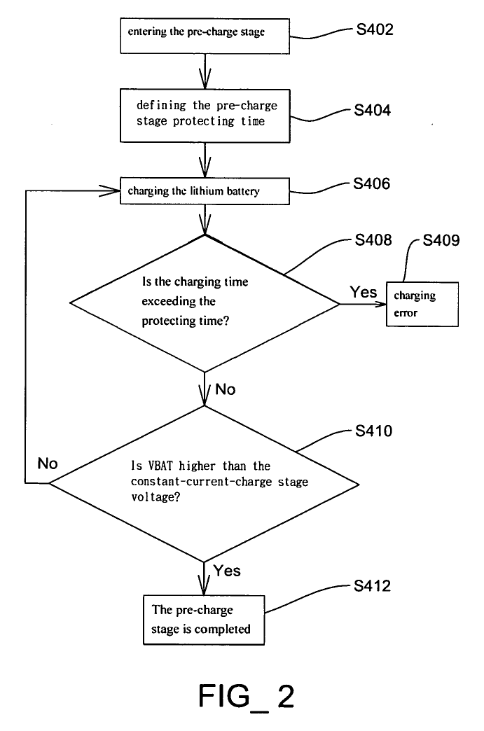

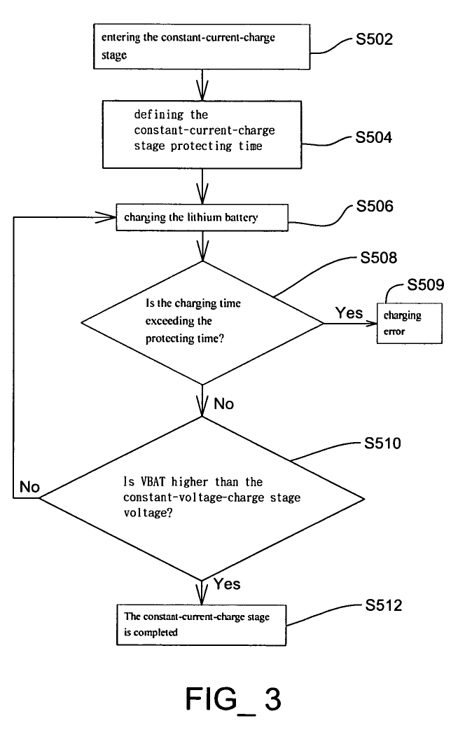

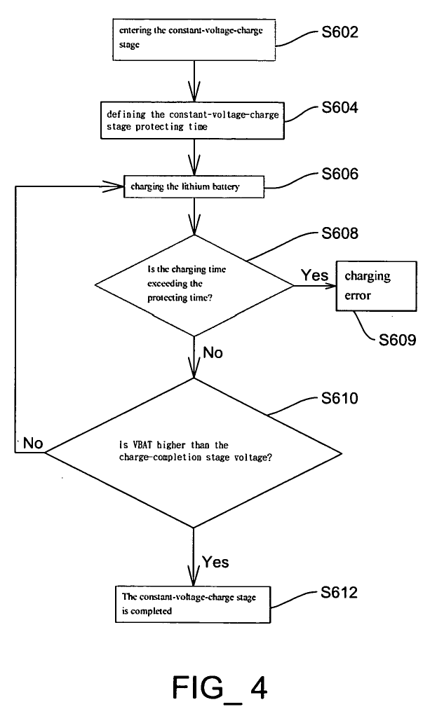

### BACKGROUND OF THE INVENTION

1. Field of the Invention

The present invention relates to a charging method for lithium battery, and more especially, relates to a charging control method for lithium battery by a microprocessor.

2. Description of the Prior Art

Due to the popularity of the wireless communication and the technological trend, a hand-held device with the features of lightness, handiness, convenience and multi-function is popular and widely used. In order to satisfy the practical and convenient requirements, the market of the batteries for the hand-held device is increasing day by day. To satisfy the requirement of the user who needs the long standby time, the charging battery with large capacity is a very important essential accessory. Further, in order to fully employ the efficiency of the charging battery, using a charging-completed battery is beneficial for the economic consideration. However, if the user doesn't know whether the battery is charged completely or not and if the charging process doesn't stop automatically, it is easy to reduce the battery lifetime, damage the battery, and be dangerous. Therefore, how to automatically check the charging status and the current voltage of the battery is one of urgent issues for the hand-held device.

### SUMMARY OF THE INVENTION

According to the issue mentioned previously, the present invention provides a charging control method for the lithium battery that may be applied to a hand-held device. The control method provides three different charging stages to charge the lithium battery, and the criterion of the charging stage selection depends on the current voltage of the battery. To charge the lithium battery by different charge conditions according to the current voltage of the battery can optimize the charging process.

One of objects of this invention is to provide a charging control method for the lithium battery. The control method exploits the Pulse Width Modulation (PWM) function to modulate the duty cycle of the control unit. According to the battery capacity difference, the modulated duty cycle can modulate the power provided by the charging unit to a constant current or a constant voltage that the lithium battery needs.

Accordingly, one embodiment of the present invention provides a charging control method, applied to a lithium battery of a hand-held device, includes: to detect a current voltage of a lithium battery; to define a plurality of stage default voltages that includes a constant-current-charge stage voltage, a constant-voltage-charge stage voltage, and a charge-completion stage voltage; to define a plurality of protection times that includes a constant-current-charge stage protection time and a constant-voltage-charge stage protection time; to modulate a power to a constant current and a constant voltage base on a pulse width modulation signal; to charge the lithium battery with the constant current within the constant-current-charge stage protection time as the voltage is less than the constant-current-charge stage voltage; and to charge the lithium battery with the constant voltage within the constant-voltage-charge stage protection time until the current voltage reaches the charge-completion stage voltage.

Other advantages of the present invention will become apparent from the following description taken in conjunction with the accompanying drawings wherein are set forth, by way of illustration and example, in certain embodiments of the present invention.

### BRIEF DESCRIPTION OF THE DRAWINGS

The foregoing aspects and many of the accompanying advantages of this invention will become more readily appreciated as the same becomes better understood by reference to the following detailed description, when taken in conjunction with the accompanying drawings, wherein:

FIG._1 is a flowchart of the charging control method in accordance with an embodiment of the present invention;

FIG._2 is a detail flowchart of the pre-charge stage in accordance with FIG_1;

FIG._3 is a detail flowchart of the constant-current-charge stage in accordance with FIG._1; and

FIG._4 is a detail flowchart of the constant-voltage-charge stage in accordance with FIG._1.

### DETAILED DESCRIPTION OF THE INVENTION

One better embodiment thereinafter is provided to explain the charging control method for a lithium battery according to an embodiment of the present invention.

FIG._1 is a flowchart of the charging control method in accordance with an embodiment of the present invention. In the present embodiment, before charging the lithium battery, a voltage detector is used to detect the current, existing voltage (VBAT) of the lithium battery (step S10) to judge the corresponding charging stage (step S20) and then to select the proper charging stage (step S30). Three charging stages are provided, and those stages include a pre-charge stage (step S40), a constant-current-charge stage (step S50), and a constant-voltage-charge stage (step S60). Please refer to FIG._2, is a detail flowchart of the pre-charge stage in accordance with FIG._1. If the detected VBAT is less than a constant-current-charge stage voltage (CC Voltage), which predetermined by the user, the charging process enters into the pre-charge stage (step S402): first of all, to define a pre-charge stage protection time, for example, 15 minutes (step S404), and to pre-charge the lithium battery with a constant current, for example, 10 mA (step S406). Within the pre-charge stage protection time (step S408), if the VBAT value of the charged lithium battery is still less than the CC Voltage (step S410), then the charging process stays in the pre-charge stage and keeps to charge the lithium battery. If not, the pre-charge stage is completed (step S412). Besides, if the processing time of the pre-charge stage is longer than the pre-charge stage protection time, it indicates an error in the charging process to fail the charging (step S409), and then the charging process stops.

Please refer to FIG._3, is a detail flow chart of the constant current stage in accordance with FIG._1. If the VBAT is more than CC Voltage at the beginning, the charging process enters into the constant-current-charge stage (step S502): first of all, to define a constant-current-charge stage protection time (step S504) and to charge the lithium battery with a constant current, for example, 0.5 C (1 C is equal to the expected charging capacity of lithium battery per hour, for example, if the expected charging capacity of lithium battery is 500 mAh, the charging current of 1 C equals to 500 mA) (step S506), wherein the constant current is generated by modulating the duty cycle of a control unit by pulse width modulation (PWM) signal of a firmware of the microprocessor. By modulating the duty cycle of the control unit, the power is modulated as a constant current that the lithium battery needs. Then, within the constant-current-charge stage protection time, for example, 90 minutes (step S508), if the VBAT does not reach the constant-voltage-charge stage voltage (CV Voltage) (step S510), then the charging process keeps to charge the lithium battery with the constant current. If not, the constant-current-chare stage is completed (step S512) and the charging process enters into the constant-voltage-charge stage. Besides, if the processing time of the constant-current-charge stage is longer than the constant-current-charge stage protection time, it indicates an error in the charging process to fail the charging (step S509), and then the charging process stops.

Please continuously refer to FIG._4, is a detail flow chart of the constant voltage stage in accordance with FIG._1. While the constant-current-charge stage is completed, the charging process enters into the constant-voltage-charge stage immediately (step S602): first of all, to define a constant-voltage-charge stage protection time (step S604) and to charge the lithium battery with a constant voltage, for example, 4.2 volts (step S606), wherein the constant voltage is generated by modulating the duty cycle of a control unit by pulse width modulation (PWM) signal of a firmware of the microprocessor. By modulating the duty cycle of the control unit, the power is modulated as a constant voltage for charging the lithium battery. During the constant-voltage-charge stage, the charging current decreases gradually, and drops to 0.1 C. Then, within the constant-voltage-charge stage protection time, for example, 90 minutes (step S608), if the VBAT of the charged lithium battery does not reach the charge-completion voltage (step S610), then the charging process keeps to charge the lithium battery with the constant voltage. If not, the constant-voltage-chare stage is completed (step S612) and the charging process of the lithium battery is completed (step S70 in FIG._1). Besides, if the constant-voltage-charge stage protection time is longer than the constant-voltage-charge stage protection time, it indicates an error in the charging process to fail the charging process (step S609), and then the charging process stops.

Additionally, during the charging process of the lithium battery, if the VBAT is higher the predetermined protecting-voltage, it indicates that the lithium battery is removed, and then the charging process stops to protect the charge system.

As mentioned above, the lengths of three protection times (the pre-charge stage, the constant-current-charge stage, and the constant-voltage-charge stage) are predetermined by the firmware of the microprocessor, and these lengths can be adjusted depending on the characteristic of the lithium battery. The charging process can allocate with a timer to stop the charging process in order to protect the lithium battery in case any unexpected wrong happens during the charging process.

To sum up, in the present embodiment, during the charging process of the lithium battery, the voltage detector detects the current voltage of the lithium battery continuously to judge and select the corresponding charging stage for the lithium battery, and then the microprocessor enables the control unit, depending on the function of pulse width modulation to modulate the power to the applicable constant current or constant voltage for charging the lithium battery. Accordingly, the charging process is completed by continuously repeating the detecting step, the judging step, the selecting step, the charging step, the comparing step, and the re-charging step.

Although the present invention has been explained in relation to its preferred embodiment, it is understood that other modifications and variation can be made without departing the spirit and scope of the invention as hereafter claimed.

What is claimed is:

1. A charging control method, applied to a lithium battery of a hand-held device, comprising:
detecting a current voltage of said lithium battery;
defining a plurality of stage default voltages, wherein said stage default voltages includes a constant-current-charge stage voltage, a constant-voltage-charge stage voltage, and a charge-completion stage voltage;
defining a plurality of protection times, wherein said protection times a constant-current-charge stage protection time and a constant-voltage-charge stage protection time;
modulating a power to a constant current and a constant voltage base on a pulse width modulation signal;
charging said lithium battery with said constant current within said constant-current-charge stage protection time in case said current voltage is less than said constant-current-charge stage voltage; and
charging said lithium battery with said constant voltage within said constant-voltage-charge stage protection time until said current voltage is more than said charge-completion stage voltage.

2. A charging control method according to claim 1, further comprising a pre-charge step, wherein said pre-charge step includes defining a pre-charge stage protection time and charging said lithium battery within said pre-charge stage protection time until said current voltage reaches said constant-current-charge stage voltage.

3. A charging control method according to claim 2, further comprising: a step to stop charging said lithium battery as said current voltage does not reach said constant-current-charge stage voltage within said pre-charge stage protection time.

4. A charging control method according to claim 2, wherein a length of said pre-charge stage protection time is predetermined by a firmware of a microprocessor and said length can be adjusted depending on the characteristic of said lithium battery.

5. A charging control method according to claim 1, further comprising: a step to stop charging said lithium battery as said current voltage does not reach said constant-voltage-charge stage voltage within said constant-current-charge stage protection time.

6. A charging control method according to claim 1, further comprising: a step to stop charging said lithium battery as said current voltage does not reach said charge-completion stage voltage within said constant-voltage-charge stage protection time.

7. A charging control method according to claim 1, wherein said pulse width modulation signal is generated by a firmware of a microprocessor.

8. A charging control method according to claim 1, wherein a magnitude of said constant current is equal to half capacity of said lithium battery.

9. A charging control method according to claim 1, wherein said constant voltage is 4.2 volts.

10. A charging control method according to claim 1, further comprising: a step to define a protecting-voltage and to stop charging said lithium battery as said current voltage reaches said protecting-voltage.

11. A charging control method according to claim 1, wherein a length of said constant-current-charge stage protection time and a length of said constant-voltage-charge stage protection time are predetermined by a firmware of a microprocessor, and said lengths are adjusted depending on the characteristic of said lithium battery.
